(19) United States
(12) Patent Application Publication
(10) Pub. No.: US 2002/0161906 A1
(43) Pub. Date: Oct. 31, 2002

(54) Method of flow management for recycled components, flow management system for recycled components, components management server for recycled components, components supply-side terminal and components request-side terminal

(76) Inventor: Nobuyuki Teraura, Tokai-shi (JP)

Correspondence Address: LAW OFFICES OF DAVID G. POSZ, 2000 L STREET, N.W., SUITE 200, WASHINGTON, DC, 20036, US

(21) Appl. No.: 10/125,399

(22) Filed: Apr. 19, 2002

(30) Foreign Application Priority Data
Apr. 27, 2001 (JP) 2001-132284

(51) Int. Cl. G06F 7/00

(52) U.S. Cl. 709/230

(57) ABSTRACT

A method and system for flow management of recycled components is disclosed, utilizing a components management server that is connected to a communication network and a components database having stored therein demand information concerning respective recycled components, whereby when the server receives an inquiry concerning a manufactured article that is to be disposed of and can be dismantled, the server searches the database to find if the specified article contains any recyclable components for which there is a demand, and transmits the search result to the inquiring party, so that these components will be removed from the manufactured article and stored. When the server receives a request for a recycled component, it searches the database to find whether or not the requested component is in stock, and transmits the search result to the requesting party, while if the component is not in stock, demand information concerning that component is registered in the database.

### BACKGROUND OF THE INVENTION

1. Field of the Invention

The present invention relates to a method of flow management for recycled components, a flow management system for recycled components, a components management server for recycled components, a components supply-side terminal and a components request-side terminal, for providing information which specifies whether there is a requirement for any recyclable components of a specified manufactured article which is to be disposed of and can be dismantled.

2. Description of the Prior Art

At present, for example when a motor vehicle is to be disposed of, those components of the motor vehicle which are capable of further usage as recycled components, and for which there is a demand, or for which there is a probability of a demand in the near future, may be removed from the vehicle and sold to a requesting party (i.e., a company or individual who is known to require that component), or stored temporarily in a facility such as a warehouse. The remainder of the vehicle is scrapped.

The selection of those components that are to be removed from a motor vehicle which is being disposed of, to be saved as recycled components, is generally performed independently at each facility where the dismantling work is carried out. As a result, components for which a requirement does not soon arise may be left stored in a warehouse for long periods of time. Conversely, some components for which a need exists, or for which it might be anticipated (if sufficient information were available to the deciding individual) that a need would soon arise, may be destroyed.

### SUMMARY OF THE INVENTION

It is an objective of the present invention to overcome the problems described above by providing a method of flow management for recycled components, a flow management system for recycled components, a components management server for recycled components that is suitable for use in such a system, a components supply-side terminal that is suitable for use in such a system, and a components request-side terminal that is suitable for use in such a system, whereby information can be provided which specifies, with respect to recyclable components of a manufactured article which is to be disposed of and can be dismantled, those recyclable components for which there is a demand.

It should be noted that the term “recycled component” or “recyclable component” as used herein can refer to a single unit component of a manufactured article, or to an assembled unit which comprises a plurality of components and is a constituent of a manufactured article.

Basically, through application of the present invention, when an inquiry is received at a components management center (transmitted via a communication network) as to whether there is a demand for any recyclable components of a manufactured article that is to be dismantled, a search is performed of information relating to recycled components, with that information being a part of components management information which is stored in a database. Based on the results of the search, demand information is sent to the inquiring party, via the network, indicating whether there is a demand for any of the recyclable components contained in the specified manufactured article, and listing those components for which there is a demand. As a result, when the specified manufactured article is disposed of, it is only necessary to perform dismantling work to remove those components for which there is a demand, for use as recycled components, with the removed components then being temporarily stored or directly supplied to one or more requesting parties, and with the remaining components of the manufactured article being scrapped without the need to perform any further dismantling work.

Hence, the dismantling work can be efficiently carried out, while in addition, components for use as recycled components can be reliably obtained, so that significant economies of operation can be achieved for that dismantling work. In addition, the amount of space which must be reserved for temporary storage of recycled components can be substantially reduced.

Typically, the demand information for a recycled component consists of a demand quantity. For example, if a request is received for a certain quantity of a recycled component when the in-stock quantity of that component is zero, then the requested quantity will be registered as the demand quantity for the component. In addition, the information registered for a recycled component includes a base quantity, which constitutes a target inventory level for the component.

If a request is received for a recyclable component for which no information has been hitherto registered at the components management center, then the quantity of the component which is requested at that time, which becomes the demand quantity, is also established as its base quantity. However in general the base quantity is established by estimating future levels of demand for a component, e.g., based on experience of previous levels of demand for the component. If at least some quantity of a component is currently held in stock, then the demand quantity is the difference between the base quantity and that in-stock quantity.

Demand information is preferably classified according to manufactured articles. That is to say, respective demand quantities for each of the recyclable components of a manufactured article are listed, in a database, linked to identifier information (e.g., model number) for that manufactured article.

As another aspect of the invention, when an offer is received (e.g., from a disposal plant having dismantling capabilities) of a recycled component for which there is a demand, and for which the corresponding in-stock quantity is zero, then the information constituting the offer can be directly sent to a requesting party, as supply information. The requesting party can thereby be immediately notified that the required component is available and will be supplied, with a minimum of data interchange being required.

In addition, when the components management center receives an offer of a recycled component for which there is a demand, the in-stock quantity which corresponds to the recycled component is incremented.

In some cases, such as when a long period of time has elapsed during which there was no demand for a component whose information has been registered in the database, the base quantity for that component may be set to zero. With the present invention, the system is preferably operated such that when a value of zero is set for the base quantity of a recycled component (i.e., indicating that there is currently no demand for that component, but that a demand previously existed) then information relating to the recycled component in the components management information is maintained during a fixed time duration. In that case, if a demand for the recycled component should subsequently occur within the fixed time duration, a new base quantity for the recycled component is established, e.g., as the requested quantity of the component.

In addition, information concerning a manufactured article containing recyclable components is recorded on a recording medium which is attached to the manufactured article and which can be read by a reading apparatus. Various types of recording medium are available, such as attachable identifier (ID) tags having information visibly printed thereon or magnetically recorded thereon, and various techniques for reading out the information, i.e., by opto-electric scanning or magnetic readout, and such a method is preferred. However it would also be possible to utilize visual recognition by a human operator who employs a keyboard or voice input apparatus to input the apparatus-specific ID information. The information thereby read from the recording medium is transmitted via a network, so that for example a dismantling facility can readily send an inquiry concerning the demand for recyclable components of a manufactured article which is to be disposed of, while a repair facility can readily request information concerning availability of recycled components for a manufactured article that is to be repaired.

The basic constituents of a flow management system according to the present invention, with regard to providing information concerning demand for recycled components are:

(1) a components management server which can be accessed from the exterior via a network,

(2) a recycled components database which can be accessed by the components management server, to provide demand information concerning recyclable components which are constituents of manufactured articles, with the demand information classified according to the manufactured articles, and

(3) a components supply-side terminal which can access the components management server via the network to send an inquiry as to whether or not there is a demand for recyclable components contained in a manufactured article.

With such a system, when the components management server receives an inquiry from the components supply-side terminal, which might for example be located in a disposal facility which can dismantle manufactured article, it accesses the recycled components database to obtain information relating to the manufactured article, and so determine whether there is a demand for any recyclable components contained in the manufactured article, and transmits the results of the search to the components supply-side terminal, as demand information concerning the recyclable components. As described hereinabove, the components supply-side terminal is preferably connected to a reader device which can automatically read information identifying the manufactured article, from a recording medium such as an ID tag that is attached to the article, so that the inquiry can readily be transmitted to the components management server.

With regard to obtaining a recycled component, e.g., when by a requesting party such as a repair facility which is repairing a certain manufactured article, such a system includes a components request-side terminal, for use by the requesting party, which can access the components management server via the network to send a request for a recycled component, while specifying a manufactured article for which the recycled component is a constituent part. Such a terminal is equipped to present (e.g., as a visible display) the contents of a response sent from the components management server in reply to the request, as supply information. As described hereinabove, the components request-side terminal is preferably connected to a reader device which can automatically read information identifying the manufactured article for which a recycled component is required, from a recording medium such as an ID tag that is attached to the article, so that the request can readily be transmitted to the components management server. The terminal “terminal” as used herein is to be understood as signifying a computer installation which is equipped with facilities for local input of data, transmitting and receiving data via a communication network, and visibly or audibly presenting inputted data or received data to an operator.

Requirements for recycled components are not limited to repair facilities (i.e., which repair the products of various different manufacturers). A service department of a manufacturer may have such a requirement, for example when service (replacement) components are required in order to repair a previously manufactured article, for which such components are no longer manufactured. In such a case, a components request-side terminal of a system according to the present invention can be located in such a service department of a manufacturing company, and be utilized in the same manner as for a repair factory.

### BRIEF DESCRIPTION OF THE DRAWINGS

FIG. 1 is a conceptual diagram showing the main features of supplying and receiving information, with a first embodiment;

FIG. 2 is a conceptual block diagram of the overall system of this embodiment;

FIGS. 3A, 3B constitute a flow diagram showing the processing for interchange of inquiries concerning demand for recycled components and corresponding responses;

FIGS. 4A, 4B constitute a flow diagram of processing for an interchange of requests for recycled components and corresponding responses; and

FIG. 5 conceptually illustrates a data format used for storing information in a recycled components database.

### DESCRIPTION OF PREFERRED EMBODIMENTS

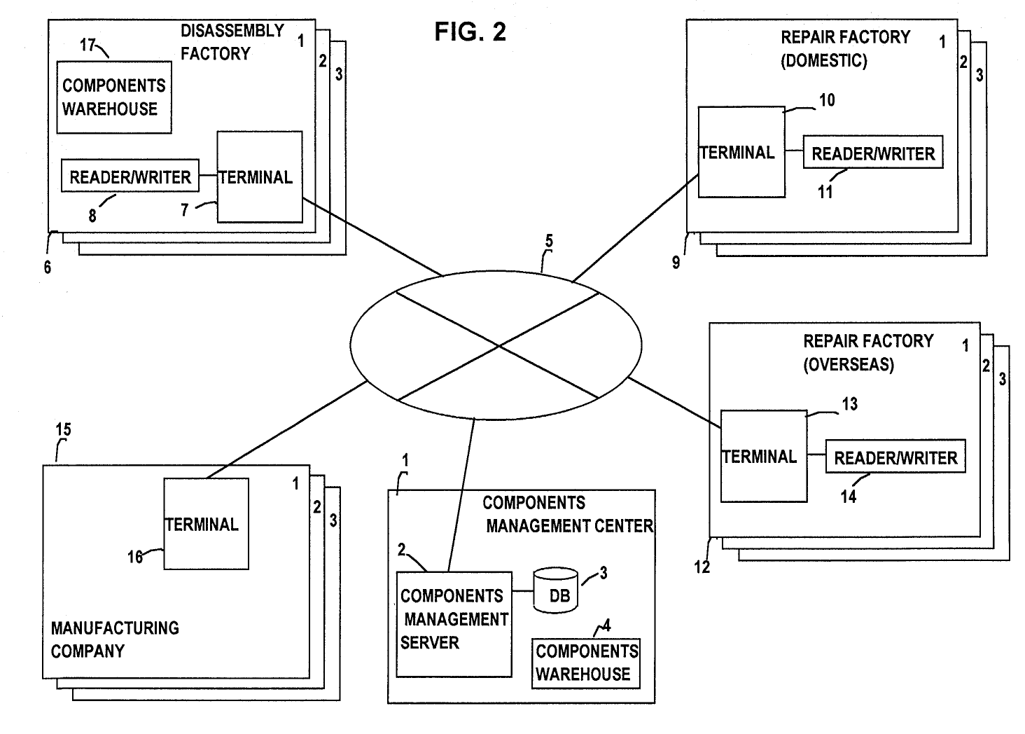

Embodiments of the invention will be described in the following referring to the drawings. FIG. 2 is a conceptual diagram showing the basic features of an embodiment of the invention. In FIG. 2, a components management center 1 constitutes the core of a flow management system for recycled components, and transmits and receives various types of information as described hereinafter. The components management center 1 basically consists of a components management server 2 and a recycled components database 3.

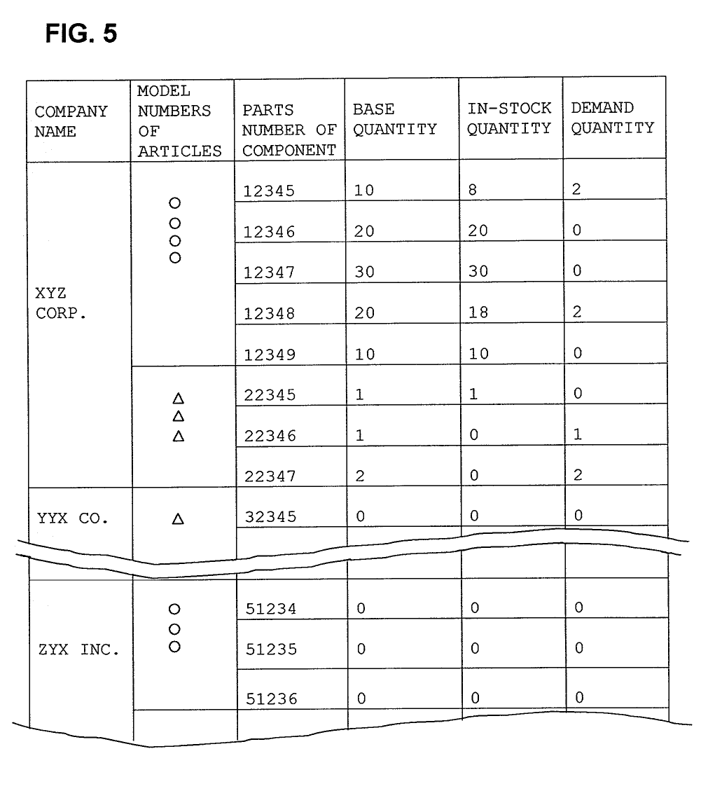

The components management server 2 is connected to the Internet 5, for access to external sources. The recycled components database 3 is used to manage demand information concerning recycled components, as components management information. The demand information is generated in a format whereby the information is specified separately for each of respective recyclable components of a manufactured article, (i.e., a unit such as an automobile, which can be dismantled to obtain such recyclable components), as described hereinafter. Such a data configuration is a main point in enabling the system to be effectively applied, and can for example be as shown in FIG. 5, whose features will be described in the following.

The components management center 1 further includes a components warehouse 4. With this system, as described in detail hereinafter, when an order for a recycled component is received at the center 1, then if the component is in stock at the warehouse 4 it can be supplied from the warehouse to the requesting party. However it would be possible for information to be transmitted from the center 1 whereby a recyclable component is sent immediately (i.e., directly or via the components management center 1) from a source such as a disassembly factory to a requesting party such as a repair factory. This could occur for example in a case in which the in-stock quantity of a recycled component is zero while a request has been received for a certain quantity of the component, and an offer is then received of a sufficient quantity of the component from a disassembly factory.

However in general, so far as possible, a certain quantity of each recycled component for which the base quantity is other than zero is maintained in the components warehouse 4, i.e., with the maximum quantity which is stored in that way being the base quantity for that component.

The system can be configured such that, if a condition of zero demand for a recycled component which is stored in the components warehouse 4 should continue for longer than a predetermined duration, then the base quantity for that component is set to zero.

Each of respective disassembly factories 6 (i.e., of a plurality of such factories, as indicated by the numerals 1, 2, 3 in the drawing) is capable of partially or completely dismantling each manufactured article which is sent thereto for disposal, to thereby remove from a manufactured article those recyclable components for which there is a demand, with any remaining part of that article then being scrapped, and with the removed recyclable components thereafter being supplied (directly, or via the components management center 1) to requesting parties. Each disassembling factory 6 includes a components supply-side terminal 7, and a reader apparatus 8 which is used to read article-specific information recorded on respective ID tags (not shown in the drawings) that are attached, as an information recording medium, to each of the manufactured articles.

Each ID tag (not shown in the drawings) attached to a manufactured article can for example have information recorded thereon in the form of a printed set of numerals or letters, or a bar code, or recorded therein as a magnetic pattern, or may be a device employing an integrated circuit (IC) chip which stores the information and operates in conjunction with electrical sensor and transducer elements. Whichever form of ID tag is utilized, the tag has recorded thereon or therein rewritable data (referred to in the following as the article-specific data) including information identifying that manufactured article, such as the model number, and information identifying each of the recyclable components of that manufactured article, such as respective parts numbers or parts replacement record information, and is used in conjunction with a reader apparatus which can scan the ID tag to convert the information recorded therein to a corresponding electrical signal. The size of such an ID tag may for example be no larger than that of a coin.

The components supply-side terminal 7 can access the components management server 2 of the components management center 1 via the Internet 5, and is used to make inquiries concerning demand information relating to recyclable components that are contained in a manufactured article which is to be dismantled. The article-specific information which is read out from the ID tag of an article is supplied to the components supply-side terminal 7, to be inserted into the contents of an inquiry, concerning demand for that article, which is transmitted by the terminal 7 to the components management center 1.

Each of respective repair factories 9 (i.e., of a plurality of such factories, as indicated by the numerals 1, 2, 3 in the drawing) which may be situated at various domestic locations, performs the work of repairing manufactured articles which are shipped thereto. In the course of such repair work, it may be necessary to insert replacement components into the manufactured article. When that occurs, it is possible that the required replacement component may not be currently available from the manufacturer, or only an insufficient quantity of the required component can be supplied, so that completion of the repair work will be delayed unless a sufficient quantity of an appropriate recycled component can be rapidly obtained. With the system of the present embodiment in such a situation it is possible for suitable recycled components, obtained from dismantled manufactured articles, to be quickly supplied for use in such repair work.

Each repair factory 9 includes a components request-side terminal 10, and a reader apparatus 11 for reading the article-specific information from the aforementioned ID tag which is attached to each manufactured article. The components request-side terminal 10 can access the components management server 2 of the components management center 1 via a data communication network, which will be assumed to be the Internet 5, for the purpose of requesting recycled components for use in repair of manufactured articles as described hereinafter. The reader apparatus 11 reads the article-specific information from the ID tag of an article which is to be repaired, and outputs the information thus read to the components request-side terminal 10.

Similarly, each of respective overseas repair factories 12 (i.e., a plurality of such factories, as indicated by the numerals 1, 2, 3 in the drawing) includes a components request-side terminal 13 and a reader apparatus 14, and function in the same manner as for the domestic repair factories.

Each of respective manufacturing companies 15 (i.e., of a plurality of such companies, as indicated by the numerals 1, 2, 3 in the drawing) produces manufactured articles, or components of manufactured articles. With this system, when it is necessary for a service department of such a company to obtain a replacement component, for use in repairing an article previously manufactured by that company (or to provide the component to some other company), it is possible that the required component is no longer being manufactured. In such a case, instead of utilizing a new component, it may be possible to obtain a recycled component which has a sufficient capability for re-use, and utilize that as a replacement component for performing the repair work.

Each of the manufacturing companies 15 contains a components request-side terminal 16, which enables access to the components management server 2 of the components management center 1 via the Internet 5, so that processing of requests for recycled components can be performed, as described hereinafter.

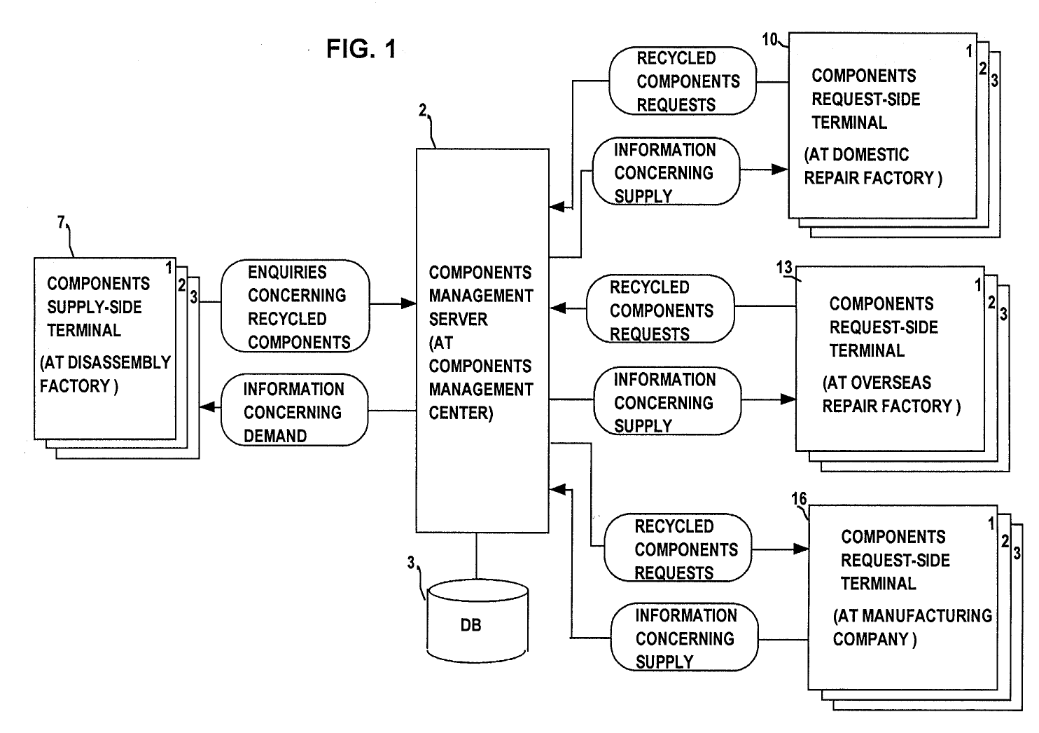

The operation of this embodiment will be described referring to FIGS. 1 and 3 to 5. FIG. 1 is a conceptual diagram showing the essential features of interchange of demand information, with this system. The components management server 2 of the components management center 1 plays a central role in handling the demand information, and exchanging information relating to recycled component with the recycled components database 3.

The recycled components database 3 can store data in the format illustrated in FIG. 5, i.e., with component management information being generated in accordance with demand information sent from the repair factories 9 or 12, or from the manufacturing companies 15. For each of respective recycled components, information concerning that component is stored in the database 3 linked to the identifier information (e.g., model number) of the manufactured article which contains that component. Preferably, as in the example of FIG. 5, the model numbers of respective manufactured articles which are produced by a specific manufacturing company are stored together, linked to the identity of that company. For example in FIG. 5, a first set of parts numbers specify components which are constituents of each of a set of manufactured articles (whose respective model numbers are indicated by the “o” symbols, which are manufactured by company “A”, while a second set of parts numbers specify components which are constituents of each of a second set of manufactured articles (whose respective model numbers are indicated by the triangle symbols, which are also manufactured by company “A”.

As shown in FIG. 5, each recycled component is assigned (in addition to its parts number) a base quantity, an in-stock quantity, and a demand quantity.

The base quantity for a recycled component is a quantity which is determined such that the component can be rapidly supplied when necessary, while maintaining a balance between the need for such a rapid supply capability with the requirement to meet a substantially constant demand for the component. Alternatively, the base quantity could be established as a quantity whereby, even if there is no demand for the component at the current time, a possible future demand for that component could be met. Depending upon changing trends in requirements of a recycled component, for example, corresponding changes may be made in the base quantity for that component.

In the case of a recycled component for which the base quantity is zero and the in-stock quantity is also zero, then this indicates that there was a demand for that recycled component in the past, and so the component was registered at that time, but that there is no demand for that recycled component at present. By maintaining information concerning a component which was registered in the past, in that manner (i.e., indefinitely, or for a fixed time duration) then if a demand for the recycled component should subsequently recur, it will be unnecessary to re-register the component. In addition, information concerning previous demand for the component can be made available.

The in-stock quantity is the quantity of a recycled component, obtained from sources such as disassembly factories, that is currently held in the components warehouse 4 of the components management center 1. The in-stock quantity of a recycled component is incremented by an appropriate amount each time that one or more units of that component are received from a source such as a disassembly factory, and is decremented by an appropriate amount each time that units of the recycled component are supplied to a requesting party.

The demand quantity of a recycled component is obtained by subtracting the in-stock quantity from the base quantity of the component. The demand quantity expresses the maximum number of units of that recycled component which should be accepted (to be stored at the components warehouse 4 of the components management center 1, or in some cases, shipped immediately to a requesting party) if offered from sources such as disassembly factories.

In the conceptual diagram of FIG. 1, the components management server 2 is disposed between the disassembling factory 6 and the components supply-side terminal 7, and responds to inquiries concerning a recycled component by searching the recycled components database 3, to obtain and provide demand information concerning that recycled component. More specifically, in response to an inquiry concerning a component, the components management server 2 checks as to whether or not data for that component exists in the database. If the component appears in the database, the components management server 2 supplies the information that there is a demand for the recycled component, while if it does not appear in the database then the components management server 2 provides the information that there is no demand for the recycled component.

The components management server 2 is also disposed between the respective terminals terminal 10 or 13, 16 of the repair factories 9 or 12 and the manufacturing companies 15. When the components management server 2 receives a request for a recycled component, it searches the recycled components database 3 to obtain and provide supply information concerning the requested component. Specifically, the components management server 2 searches to find whether or not the desired recycled component is listed in the database and is currently in stock. If so, the components management server 2 provides supply information which indicates that the requested component can be immediately supplied. If the requested recycled component does not exist in the database, then since this indicates that it is a recycled component for which there is a new demand, processing to register the component is performed, and the information that the requested component is not available but has been newly registered is provided, as the supply information.

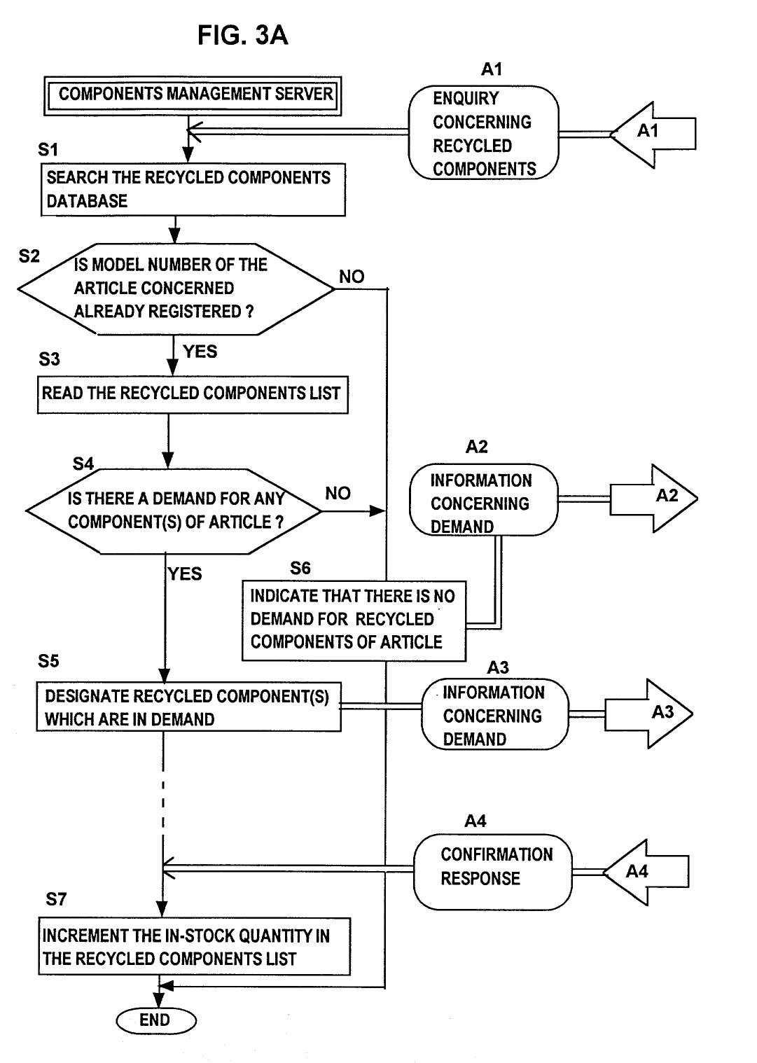

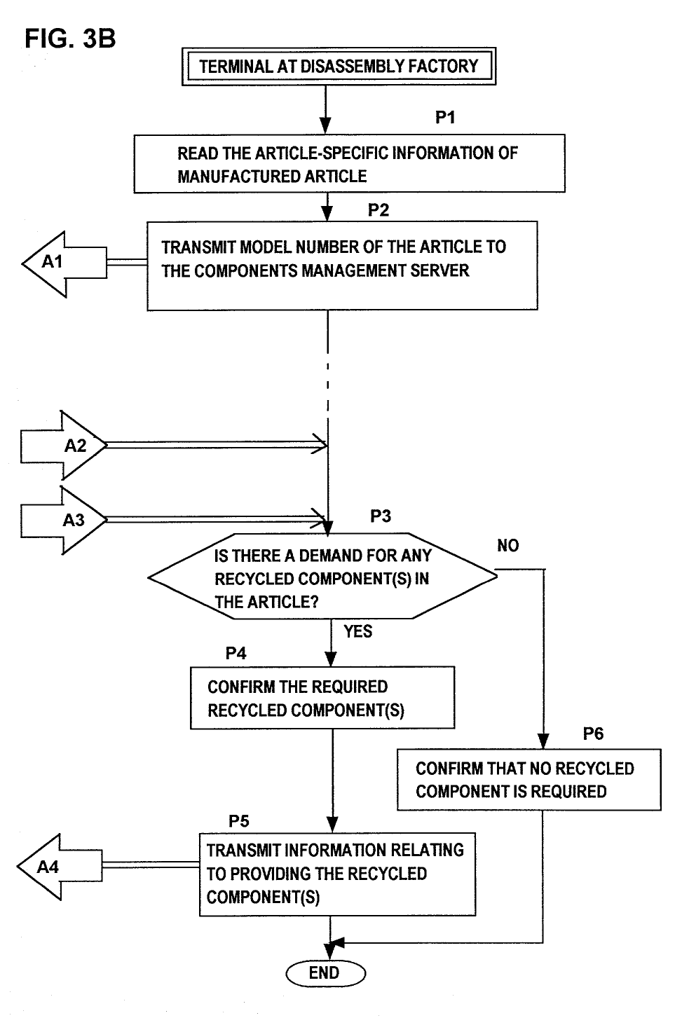

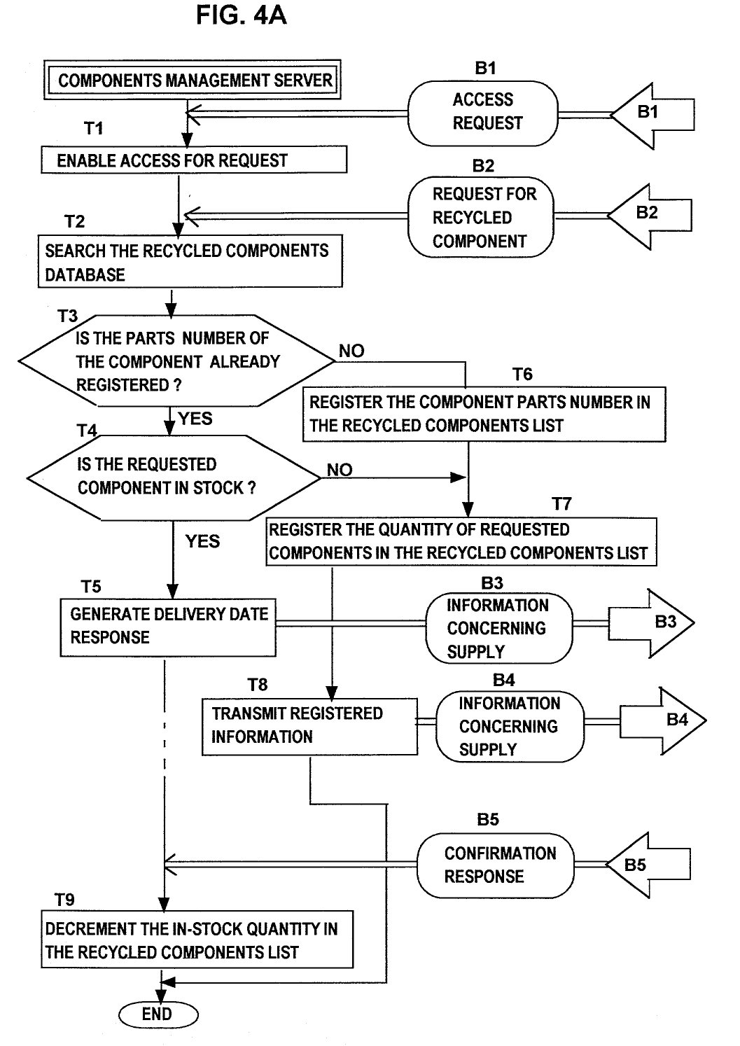

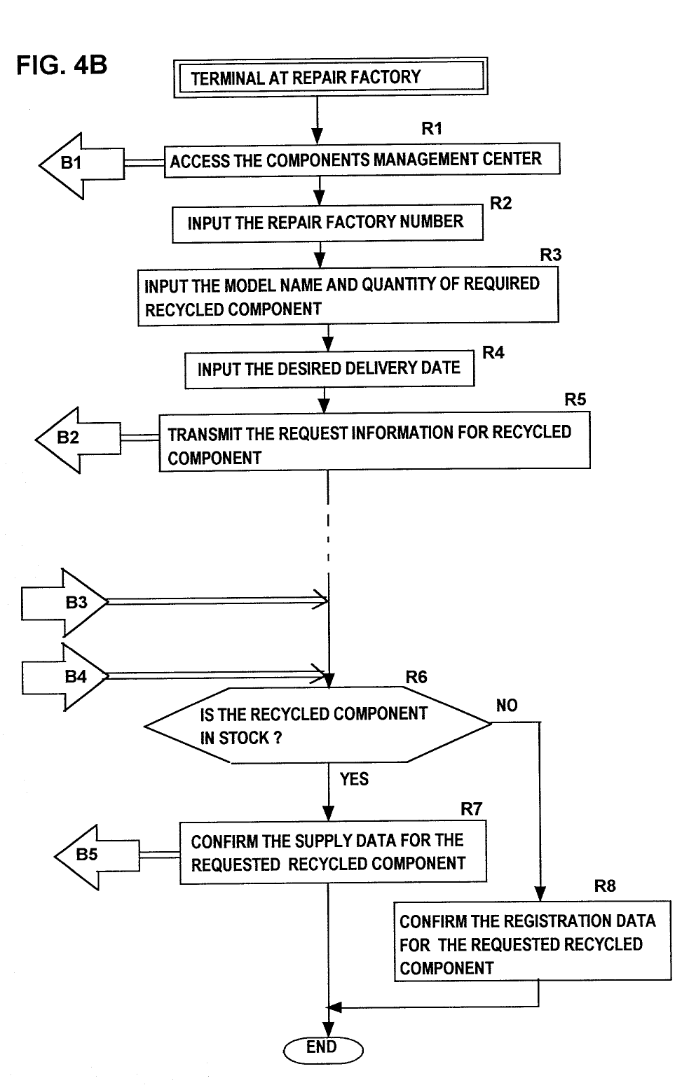

The interchange of data between the components management server 2 and the components supply-side terminal 7 will be described referring to the flow diagram of FIGS. 3A, 3B. The interchange of data between the components management server 2 and the component request-side terminals 10 or 13, 16 will be described referring to the flow diagram of FIGS. 4A, 4B.

Demand Inquiry Concerning Recycled Component, and Corresponding Response Processing

Referring to FIGS. 2 and 3A, 3B, when a manufactured article is to be disposed of at a disassembling factory 6, the ID tag which is attached to that article is read by the reader apparatus 8, and the article-specific information which is registered in the ID tag is read into the components supply-side terminal 7 (step P1). Next, the model number of that article (contained in the data which have been read) is transmitted to the components management server 2 (step P2). As a result, the components supply-side terminal 7 accesses the components management server 2 via the Internet 5, to send an inquiry (A1) concerning recyclable components which may be contained in the manufactured article that is to be dismantled, and then waits for a response from the components management server 2

When the components management server 2 receives the inquiry A1 concerning recycled components, it accesses the recycled components database 3 to determine whether there is a demand for any of the recyclable components of the manufactured article concerned (step S1). If that manufactured article has been registered in the database (i.e., a YES decision in step S2) then the list of recycled components is read (step S3), and a decision is made as to whether or not there is a demand for any of the recyclable components which are contained in the specified manufactured article (step S4). If it is found that there is a demand for one or more of these recyclable components, then the components management server 2 generates “demand information” (A3) which specifies those components (step S5). On the other hand if it is found that the specified manufactured article is not registered in the database (i.e., NO decision in step S2) or if there is no demand for any of the recyclable components of that manufactured article (i.e., NO decision in step S4), then information (A2) indicating that there is no demand for recyclable components from the specified manufactured article is generated by the components management server 2 and transmitted via the Internet to the inquiring disassembly factory (step S6).

The components management server 2 thereby sends to the components supply-side terminal 7 either the demand information A2 which instructs that there is no demand for components of the specified manufactured article, or the demand information A3 which contains a list of those components of the specified manufactured article that are in demand, for use as recycled components. Thus, appropriate demand information is transmitted to the components supply-side terminal 7 in response to its inquiry.

If the demand information A3 is received by the components supply-side terminal 7, indicating those components of the specified manufactured article which are required for use as recycled components (i.e., YES decision in step P3) then the components supply-side terminal 7 (which was in the waiting condition) presents the contents of the demand information A3 to an operator, and the operator then inputs a confirmation that the displayed information has been noted (step P4). The components supply-side terminal 7 thereby generates information for confirming that the listed recyclable components will be obtained by dismantling work on the specified manufactured article and will then be sent to the components management center 1 (step P5). This information is transmitted from the components supply-side terminal 7 to the components management server 2 as a confirmation response (A4).

If it is found that there is no demand for any recyclable component of the specified manufactured article, so that the demand information A2 is received at the components supply-side terminal 7, then information indicating that fact is presented to an operator by the components supply-side terminal 7, and the operator then inputs a confirmation that the information has been noted (step P6). Program operation then ends.

When the components management server 2 receives the confirmation response A4 from the components supply-side terminal 7, then since this will result in respective quantities of recycled components held in the components warehouse 7 of the components management center 1 being increased, the respective in-stock quantities for these recycled components (held in the database 3) are incremented accordingly, in accordance with the supply information A4 received from the components supply-side terminal 7. Program operation then ends.

It should be noted that in a case in which a component has been requested by one or more of the component request-side terminals terminal 10 or 13 or 16 (i.e., that component is “on order” but is not currently in stock at the components management center 1) then when that component is obtained by the components management center 1 through the process described above, the in-stock quantity for that component is first incremented by the processing step S7, the component is then immediately supplied to the requesting party, and the in-stock quantity for that component is then decremented accordingly.

Thus as can be understood from the above description, when it is necessary to determine if there is a demand for recyclable components that are constituents of a manufactured article which is to be dismantled, the components management server 2 can rapidly perform a search to find if such a demand exists. Hence, increased efficiency of dismantling work can be achieved. In addition it becomes unnecessary for a disassembly factory to hold recycled components, obtained by dismantling work, in a warehouse over a long period of time, since the recycled components can be quickly be marketed.

Requests for Recycled Components, and Corresponding Response Processing

This processing will be described referring to FIGS. 2 and 4A, 4B, At each of the repair factories 9 or 12, when a need arises for a recycled component to be used in repairing a manufactured article, a request for the recycled component is sent to the components management server 2 of the components management center 1, as follows. Firstly, a components request-side terminal 10 or 13 of a repair factory accesses the components management server 2 via the Internet 5 (step R1) by transmitting an access request (B1), to move into a status in which a request can be made. When the components management server 2 receives the access request from the terminal 10 or 13, it enters a status in which request processing can be executed (step T1).

The terminal 10 or 13 is then supplied with information which can be inputted automatically or by an operator. Firstly, a registration number that has been assigned beforehand to the factory concerned is inputted (step R2), information identifying the required recycled component (e.g., a parts number) is inputted (step R3), then a desired delivery date for the recycled components is inputted (step R4). The information which has thus been supplied to the terminal 10 or 13 is then transmitted to the components management server 2 via the Internet 5, as request information (B2) for the recycled components (step R5).

By assigning predetermined registration numbers to each of the repair factories as described above, these numbers can be automatically transmitted when the components management server 2 is accessed (i.e., it is not actually necessary for the factory registration number to be inputted to the components request-side terminal 10 or 13 before transmitting the access request B1). Furthermore, since information such as model numbers of manufactured articles and parts numbers of recycled components is provided on respective ID tags that are attached to the articles, information identifying a required recycled component can be automatically inputted by using the reader-writer 11 or 14 to scan the ID tag, so that the work of inputting information to a terminal 10 or 13 can be rapidly and accurately performed.

When the components management server 2 receives a request (B2) for a recycled component from a terminal 10 or 13, it responds by accessing the recycled components database 3 to search for the requested component (step T2). If it is found that the requested recycled component is registered in the database (i.e., YES in step T3), a decision is made as to whether or not that recycled component is currently in stock (step T4). If it is found that the recycled component is in stock (YES decision), then information specifying a delivery date for the recycled component is sent to the terminal 10 or 13, as supply information B3 (step T5).

However it may be found that the requested recycled component is not registered (NO in step T3). In that case the components management server 2 registers the identification information (e.g., parts number) of that recycled component in its list of recycled components (step T6). At that time, if the manufactured article containing the requested recycled component is not already registered in the database 3, then the identifying information (e.g., model number) of the manufactured article is also registered in conjunction with the information registered for that recycled component.

Next, the requested quantity of the recycled component is registered as the demand quantity and also as the base quantity for that component (step T7). If a NO decision is made in step T4, i.e., the specified recycled component is already registered but the in-stock quantity of that component is zero, then the components management server 2 executes step T7.

It is possible that in actuality, even if an appropriate base quantity has been established for a recycled component, the in-stock quantity may be insufficient, or zero. This signifies that only a small number of that recycled component is in circulation, and so increasing the base quantity for that recycled component, in accordance with in an increase in the corresponding demand quantity, may not be desirable. Thus if the base quantity has already been set at some value for the recycled component concerned, it may be possible to skip the step T7 of the processing sequence described above, after a NO decision is reached in step T4.

If the demand quantity for a recycled component is increased under a condition in which that component is not currently in stock, or if a recycled component has been found to be in demand and has thereby been newly registered in the list of recycled components, the registration information is transmitted as the supply information B4 to the terminal 10 or 13, i.e., indicating that the requested recycled component cannot be supplied at that time.

When the terminal 10 or 13 receives the supply information B3 or B4, a decision is made as to whether or not the recycled component can be obtained. If the recycled component can be obtained (i.e., the supply information B3 has been received) so that a YES decision is made in step R6, then when an operator has noted that information, a confirmation response (B5) is transmitted to the components management server 2. If however the requested recycled component is not available (i.e., the supply information B4 has been received), so that a NO decision is made in step R6, then an operator at the terminal 10 or 13 inputs to that terminal a confirmation that the information B4 has been received (step R8) and the program operation then ends.

When the components management server 2 receives the confirmation response B5 from the terminal 10 or 13, it decrements the in-stock quantity that is registered for the recycled component concerned, in the recycled components list held in the recycled components database 3 (i.e., since one or more units of that recycled component will then be supplied to the requesting party) and program operation then ends.

As a result, if a requested recycled component is in stock, supply information (B3) can be rapidly transmitted, whereby the requested component can be quickly supplied. If the requested recycled component is not in stock, then that fact can be newly registered as demand information, and the system then enters a condition of waiting until that component becomes available. Thus here again, a rapid response to a request for a recycled component can be achieved.

Since recycled components can be requested as individual units, even if a plurality of different types of recycled component become successively required during repair work that is carried out on a manufactured article, it can be rapidly ascertained whether or not each of these recycled components is in stock. Hence the repair work can be efficiently performed.

In the processing described above, the repair factories 9 or 12 have respective component request-side terminals 12, 13, which are used to perform processing for requesting recycled components. The components request-side terminal 16 of each manufacturing companies 15 can be similarly used to request recycled components, with the only difference from the processing described above being that the obtained recycled components are utilized in repair work or servicing that is performed on articles of a single manufacturer. Thus, similar effects to those described above can be achieved in that case, so that detailed description will be omitted.

With the above embodiment, the components management server 2 which manages the demand information relating to recycled components is installed at a components management center 1, and can be accessed from repair factories and manufacturing companies via the Internet 5. Thus when dismantling work is being carried out, it is possible to rapidly determine whether there is a demand for any components of a manufactured article which is being dismantled. It thereby becomes possible to perform such dismantling work by removing only those components of a manufactured article for which there actually is a demand, so that the efficiency of such dismantling work can be enhanced. Furthermore, this also ensures that it is only necessary for the disassembly factory to hold in stock those recycled components for which there is a demand.

Moreover the embodiment enables a repair factory or manufacturing company to rapidly and reliably obtain recycled components. In particular, this has the advantage that it becomes less necessary for a manufacturing company to maintain production lines in operation over a long period of time, in order to manufacture components as spare parts for use in servicing previously manufactured articles, so that production efficiency can be increased.

Furthermore with the embodiment described above, since requested recycled components can be quickly provided, manufactured articles which are dismantled can be rapidly re-utilized, so that resources are utilized in an efficient and economical manner.

It should be noted that the invention is not limited to the embodiment described above, but that the following modifications could be envisaged. Firstly, with the described embodiment, a recording medium is used which consists of ID tags that are attached (i.e., in general, removably attached) to manufactured articles, and which are read out to obtain article-specific information. However the invention is not limited to the use of ID tags containing rewritable information, and such article-specific information could for example be recorded and read out by using conventional bar codes, or 2-dimensional bar codes, etc., or sets of numerals or characters, which could be directly printed on a surface of a manufactured article. Furthermore it is not essential that a recording medium be utilized. It would be possible for example to input such article-specific information by an operator using a keyboard or a voice-input apparatus, based on model numbers and parts numbers which are directly printed on manufactured articles and components.

When performing dismantling work or repair work, it may be difficult for an operator to perform the work by using an interface such as a keyboard. In such a case, the use of a voice-input system or a voice-guidance system could be envisaged, to increase efficiency.

Furthermore in the above description of embodiments, it is assumed that the components management center 1 includes a warehouse 4 for storing recycled components, so that the center can sell recycled components, previously obtained from the disassembly factories, to requesting parties. However it would be equally possible to configure a system whereby the components management center 1 deals only in information. That is to say, the center would not receive or store any recycled components, but instead would receive monetary payments from the disassembling factory 6, the repair factories 9 or 12, or the manufacturing companies 15, in return for providing supply information and demand information concerning recycled components. With such a system for example, each of the disassembly factories might maintain respective warehouse facilities, with quantities of recycled components being stored therein in accordance with components management information for the respective components, supplied from the components management center 1, and with the components being supplied directly from the disassembly factories to requesting parties such as repair factories.

It should also be noted that it would be equally possible for a system according to the present invention to use various types of communication network other than the Internet for receiving/supplying information, such as a telephone network, a LAN, etc

What is claimed is:

1. A method of flow management for recycled components comprising
preparing components management information which is configured such as to enable demand information to be provided concerning recyclable components which are constituents of manufactured articles, with the demand information being classified in accordance with respective manufactured articles,
receiving, via a network, an inquiry as to whether or not a manufactured article that is to be dismantled contains recyclable components for which there is a demand, and
performing a search of said components management information, in response to said inquiry, to determine whether there is a demand for any of the components of the specified manufactured article, and providing the results of said search via said network, as demand information.

2. The method of flow management according to claim 1, wherein said components management information for recycled components has a configuration whereby a request from a requesting party for a recycled component is utilized as said demand information, and whereby the demand information is provided respectively separately for respective manufactured articles of which said recycled component is a constituent.

3. The method of flow management according to claim 1, wherein said components management information for recycled components has a configuration whereby said demand information for a recycled component is at least partially determined based upon anticipated future demand for said recycled component.

4. The method of flow management according to claim 1, wherein upon receiving an offer of a recycled component for which there-is a demand, obtained by dismantling a manufactured article, said offer is provided, as supply information, to a requesting party which has requested said recycled component.

5. The method of flow management according to claim 3, wherein upon receiving an offer of a recycled component for which there is a demand, obtained by dismantling a manufactured article, an in-stock quantity which forms part of said components management information and which corresponds to said recycled component is incremented.

6. The method of flow management according to claim 5, wherein in said components management information, a requested quantity of a recycled component is set as a base quantity for said recycled component, while in addition a quantity of said recycled component that is currently held in stock is set as an in-stock quantity for said recycled component, and wherein said demand quantity is obtained by subtracting said in-stock quantity from said base quantity.

7. The method of flow management according to claim 6, wherein in said components management information,
when a value of zero is reached for said base quantity, of a recycled component for which there is currently no demand but for which there was previously a demand, then information relating to said recycled component in said components management information is maintained during a fixed time duration, and
when a demand for said recycled component subsequently arises within said fixed time duration, said base quantity for said recycled component is updated in accordance with a requested quantity of said component.

8. The method of flow management according to claim 1, wherein said recycled component is a single component of a manufactured article, or is an assembled unit which comprises a plurality of components and is a constituent of a manufactured article.

9. The method of flow management according to claim 1, wherein information concerning said manufactured article containing said recycled components is recorded on a recording medium which is attached to said manufactured article and which can be read out, as information expressed by an electrical signal, by a reading apparatus, and wherein information thereby read from said recording medium can be transmitted via said network.

10. A flow management system comprising
a components management server which can be accessed from the exterior via a network,
a recycled components database which can be accessed by said components management server, to provide demand information concerning recyclable components which are constituents of manufactured articles, with the demand information classified according to the manufactured articles, and
a components supply-side terminal which can access said components management server via said network to send an inquiry as to whether or not there is a demand for recyclable components contained in a manufactured article;
wherein, when said components management server receives said inquiry from said components supply-side terminal, said components management server accesses said recycled components database for information relating to said manufactured article, to determine whether or not there is a demand for said recyclable components contained in said manufactured article, and supplies results obtained from said search to said components supply-side terminal, as demand information concerning said recyclable components.

11. A flow management system according to claim 10, wherein
an information receiving medium having written therein article-specific information which is specific to said manufactured article is attached beforehand to said manufactured article, and
said components supply-side terminal is provided with a reader apparatus for reading said article-specific information from said information recording medium as an electrical signal expressing said information,
and wherein when an inquiry is to be sent from said components supply-side terminal to said components management server to determine whether or not there is a demand for recycled components contained in said manufactured article, said article-specific information for said manufactured article is read from said information recording medium by said reader apparatus and is transmitted in said inquiry, and
wherein said components management server provides said demand information based upon said article-specific information, when received thereby.

12. A components management server for use in a recycled components flow management system which provides demand information concerning recyclable components, wherein said components management server is configured such that
when said components management server receives an inquiry, sent from a supply-side terminal via a network, as to whether or not there are recyclable components contained in a manufactured article, said components management server accesses a recycled components database which can provide demand information concerning recyclable components contained in manufactured articles, with said demand information classified according to manufactured articles, for thereby performing a search of said recycled components database to determine whether or not there is a demand for recyclable components contained in said manufactured article specified in said inquiry, and
said components management server transmits results obtained from said search, as demand information, to said components supply-side terminal.

13. A components supply-side terminal for use in a recycled components flow management system having a components management server which provides demand information concerning recyclable components contained in manufactured articles in response to inquiries, wherein said components supply-side terminal
sends an inquiry, as to whether or not there are recyclable components contained in a specified manufactured article, by accessing said components management server via a network, and
upon receiving search results from said components management server, visibly or audibly presents demand information concerning said components of said manufactured article.

14. A components supply-side terminal according to claim 13, wherein when said components supply-side terminal sends an inquiry as to whether or not there are recyclable components contained in a manufactured article, article-specific information recorded on an information recording medium attached to said manufactured article is electrically read out by a reader apparatus, and said article-specific information is transmitted in said inquiry.

15. A components request-side terminal for use in a recycled components flow management system having a components management server which provides demand information concerning recyclable components contained in manufactured articles in response to inquiries, wherein said components request-side terminal
accesses said components management server via said network to send a request for a recycled component, while specifying a manufactured article corresponding to said recycled component, and
visibly or audibly presents the contents of a response sent from said components management server in reply to said request, as supply information.

16. The components request-side terminal according to claim 15, wherein when a manufactured article is being repaired and a need arises for a recycled component for use as an internal component of said article, article-specific information which is recorded on an information recording medium that is attached to said manufactured article is read out by a reader apparatus, to be expressed as an electrical signal, and is transmitted.

17. The components request-side terminal according to claim 15, wherein said components request-side terminal is disposed as a terminal of a manufacturer of said manufactured articles, and wherein said components request-side terminal is configured to be capable of sending a request to said components management server when a need arises for a recycled component to be utilized in repairing a manufactured article.
